(19) United States
(12) Patent Application Publication
(10) Pub. No.: US 2004/0135123 A1
(43) Pub. Date: Jul. 15, 2004

(54) High efficiency phosphor

(75) Inventors: Martin Judenhofer, Munchen (DE); Manfred Kobusch, Muenchen (DE)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OSRAM OPTO SEMICONDUCTORS, REGENSBURG (DE)

(21) Appl. No.: 10/477,549

(22) PCT Filed: Jun. 7, 2001
(86) PCT No.: PCT/DE01/02131

(30) Foreign Application Priority Data
May 29, 2001 (DE) 201 08 873.8

(51) Int. Cl. C09K 11/56

(52) U.S. Cl. 252/301.4 S

(57) ABSTRACT

Phosphor from the class of the thiometallates, preferably of the thiogallates, the thiometallate being made up so as to correspond to the formula (AS).w(B₂S₃), where A is at least one divalent cation selected from the group consisting of Ba individually or in combination with Mg and/or Ca, and where B is at least one trivalent cation selected from the group consisting of Al, Ga, Y, where the factor w may lie either in the range 0.8≦w≦0.98 or in the range 1.02≦w≦1.2.

### TECHNICAL FIELD

The invention is based on a phosphor from the class of thiometallates, in accordance with the preamble of claim 1, the thiometallate being derived from the general formula AB₂S₄:D²⁺, where A is at least one divalent cation selected from the group consisting of Ba individually or in combination with Mg and/or Ca, and where B is at least one trivalent cation selected from the group consisting of Al, Ga, Y, and where the dopant/activator D is europium and/or cerium. The proportion made up by divalent cation A is reduced by the proportion t of the activator D which is added. These are in particular thiogallates, which emit light in the green spectral region. The composition of the phosphor is made up in such a way that the molar ratio of divalent ions A to trivalent ions B in the general empirical formula AB₂S₄ does not precisely correspond to the ratio A:B=1:2.

### PRIOR ART

U.S. Pat. No. 3,639,254 and U.S. Pat. No. 5,834,053 have already disclosed thiogallates, the emission spectra of which lie in the blue or green spectral region. These phosphors follow the formula AGa₂S₄, where A represents at least one element from the group of the alkaline-earth metals, in particular Ca, Ba, Sr or Zn. Activators are europium, lead or cerium. However, for applications which require a high light efficiency (e.g. illumination engineering), the emission efficiencies of said phosphors are too low. This emission efficiency is expressed by what is known as the quantum efficiency QE (ratio of number of quanta emitted to the number of excitation quanta absorbed). Typical quantum efficiencies for said phosphors are between 60% and 70%.

WO 98/18721 has disclosed an electroluminescent phosphor selected from the group of the thiometallates, with Sr or another alkaline-earth metal as divalent cation, Ga, Al or In acting as the trivalent cation. In particular, this document describes a production process which retains a certain amount of residual oxygen.

### SUMMARY OF THE INVENTION

It is an object of the present invention to provide a phosphor in accordance with the preamble of claim 1 which has a quantum efficiency which is as high as possible for a predetermined emission wavelength.

This object is achieved by the characterizing features of claim 1. Particularly advantageous configurations are given in the dependent claims.

According to the invention, the composition of the phosphor is selected in such a way that the ratio of divalent ions A to trivalent ions B, working on the basis of the general empirical formula AB₂S₄, differs from the ratio A:B=1:2. The concept of the invention can also be expressed in a different way if the thiometallates of the original empirical formula AB₂S₄ are written as a product of the components AS and B₂S₃ in the form AS.B₂S₃. The ratio of the component AS to the component B₂S₃ is described below by the factor w=B₂S₃/AS. The overall result is that the thiometallate is represented as (AS).w(B₂S₃) It has been found that phosphors having the composition (AS).w(B₂S₃) provide higher quantum efficiencies than phosphors with the composition w=1 both in the range 0.8≦w≦0.98 and in the range 1.02≦w≦1.2.

The combination of various cations of type A and B makes it possible to achieve different emission wavelengths and color loci and to adapt them to the particular application. For an efficient (“bright”) phosphor, there must additionally be a low reflection in the excitation range and a high quantum efficiency. Ba, individually or in combination with Mg, Ca, particularly a combination of all three cations, is suitable as cation A. Europium and/or cerium are suitable activators which partially replace A. It is preferable for Ga or Al or Y to be used as cation B. The gallium may in this case in particular be partially replaced (up to 10 mol %) by aluminum. The dopant D (D=Eu and/or Ce) is counted completely as part of the sub-component AS, i.e. represented in full the formula is Aₗ₋ₜDₜS.

Phosphors having the composition (AS).w(B₂S₃), where A=MgₐCa_{b}Ba_{c}Euₜ, with a+b+c+t=1, where the following ranges apply: 0.4≦a≦0.8; 0.05≦b≦0.35; 0.05≦c≦0.4; 0.01≦t≦0.1 and B=(GaₓAl_{y}Y_{z})₂ with x+y+z=1 and 0.9≦x≦1 and 0≦y≦0.1 and 0≦z≦0.1 and 0.8≦w≦0.98 or 1.02≦w≦1.2, have particularly high quantum efficiencies.

Another preferred embodiment comprises phosphors having the composition (AS).w(B₂S₃), where

A=MgₐBa_{b}Euₜ, with a+b+t=1:0.4≦a≦0.8; 0.1≦b≦0.59; 0.01≦t≦0.1; and B=(GaₓAl_{y}Y_{z})₂, with x+y+z=1 and 0.9≦x≦1 and 0≦y≦0.1 and 0≦z≦0.1; and 0.8≦w≦0.98 or 1.02≦w≦1.2.

A production process employs the following steps:

a) production of a suspension of nitrates corresponding to the desired composition;

c) drying of this suspension to a residual moisture content of <1% by weight at T<300° C., in order to produce a finely dispersed nitrate mixture;

c) milling of the nitrate mixture in a mortar mill at room temperature for 10 min to 60 min, preferably 15 to 25 min;

d) pyrolysis of the milled nitrate mix at 500-700° C., preferably at 600° C., in an Ar or N₂ atmosphere in order to produce a finely dispersed metal oxide mixture of the desired composition;

e) initial reaction of the metal oxide mixture at 800-1000° C., preferably 900-950° C., in flowing H₂S or CS₂ atmosphere or combinations thereof for 1-6 hours, preferably 4 hours;

f) milling the reaction product as in step c;

g) second reaction at 800-1000° C., preferably 900-950° C., in a flowing H₂S or CS₂ atmosphere or combinations thereof for 1-6 h, preferably for 2 h.

In steps e) and g), the quantitative flow rate is preferably 50-500 ml/min, ideally 120 ml/min, and the gas atmosphere preferably comprises HₛS or CS₂ and Ar or N₂ as carrier gas, with 10-50% of H₂S or CS₂ or mixtures thereof, preferably 30% of H₂S or CS₂ or mixtures thereof.

Gradual heating up to the reaction temperature is carried out in steps e) and g), preferably at a rate of 0.5-20 K/min, ideally 10 K/min.

Moreover, in steps e) and g) gradual cooling is carried out after the reaction, preferably at a rate of 0.5-20 K/min, ideally 10 K/min.

The phosphors according to the invention are particularly suitable for use in UV-emitting or blue-emitting LEDs for color conversion. They can be used individually or in combination with other phosphors, in particular in combination with other phosphors according to the invention. Plasma displays are another possible application. For this purpose too, the phosphors may be used individually or in combination with other phosphors, in particular in combination with other phosphors according to the invention, in order to convert the short-wave plasma discharge radiation into visible light.

### FIGURES

The invention is to be explained in more detail below with reference to an exemplary embodiment. In the figures:

FIG. 1 shows the emission spectrum of the phosphor (Ba_{0.2}Ca_{0.15}Mg_{0.6}Eu_{0.05})S.1.1Ga₂S₃, produced using the process described in the exemplary embodiment;

FIG. 2 shows the reflection spectrum of the phosphor from FIG. 1.

### EXEMPLARY EMBODIMENTS

To produce a phosphor having the composition (Ba_{0.2}Ca_{0.15}Mg_{0.6}Eu_{0.05})S.1.1Ga₂S₃, high-purity oxides and/or carbonates in the quantities which correspond to the formula are weighed in as starting materials and a homogenous, finely milled mixture of the oxides is produced. This mixture of raw materials is mixed in equimolar quantities with approximately 30% strength nitric acid, is heated until it is gently boiling and is reacted to form nitrates. The following reaction equation applies:

0.20 mol BaCO₃+0.15 mol CaCO₃+0.6 mol MgO+0.025 mol Eu₂O₃+1.100 mol Ga₂O₃+8.6 mol HNO₃→0.20 mol Ba²⁺0.15 mol Ca²⁺+0.60 mol Mg²⁺+0.05 mol Eu³⁺+2.20 mol Ga³⁺+8.6 mol NO₃⁻+4.3 mol H₂O+0.35 mol CO₂↑

A white suspension of precipitated nitrates is formed. This suspension is evaporated until it reaches a highly viscous state. The nitrate suspension obtained is transferred into a quartz boat and is dried in a stream of nitrogen at 300° C.

The dried nitrate mixture is milled in a mortar mill for 20 minutes and is then pyrolyzed at 600° C. for four hours under nitrogen, in accordance with the following reaction equation:

0.20 mol Ba(NO₃)₂+0.15 mol Ca(NO₃)₂+0.60 mol Mg(NO₃)₂+0.05 mol Eu(NO₃)₃+2.20 mol Ga(NO₃)₃→1 mol [0.20BaO.0.15CaO.0.60MgO.0.025Eu₂O₃.1.10Ga₂O₃]+8.6 mol NO₂+2.15 mol O₂.

The oxide mixture which is produced is introduced into a quartz boat and is heated to 900° C. in a tubular furnace under inert gas (argon). After the reaction temperature has been reached, 120 ml of hydrogen sulfide, 30% of H₂S/min in the stream of nitrogen, is introduced and the oxide mixture is reacted over the course of four hours to form the thiogallate, in accordance with the following reaction equation:

1 mol [0.20BaO.0.15CaO.0.60MgO.0.025Eu₂O₃.1.10Ga₂O₃]+4.325 mol H₂S→(Ba_{0.20}Ca_{0.15}Mg_{0.60}Eu_{0.05})S.1.1Ga₂S₃+4.325 mol H₂O+0.025 mol S.

A temperature of 870 to 930° C. has proven to be the optimum reaction temperature for a high-efficiency phosphor.

The reaction product is milled for 10 minutes in a mortar mill and is then reacted for a further three hours in 20% strength flowing hydrogen sulfide at 900° C.

This process can be used to reproducibly produce high-efficiency phosphors of the abovementioned compositions.

Compared to a phosphor of the formula (Ba_{0.20}Ca_{0.15}Mg_{0.60}Eu_{0.05})S.1.0Ga₂S₃ (w=1), this phosphor has a quantum efficiency which is improved by 16%, while the emission spectrum remains unchanged, with an intensity maximum at 535 nm ±3 nm, or, compared to the phosphor

(Ba_{0.20}Ca_{0.15}Mg_{0.60}Eu_{0.05})S.1.0Ga₂S₃ (w=1), the phosphor (Ba_{0.38}Mg_{0.57}Eu_{0.05})S.0.9Ga₂S₃ (w=0.9) has a quantum efficiency which is increased by 16% and the intensity maximum of the emission spectrum of these phosphor compositions is in the range of from 508-513 nm.

Further exemplary embodiments led to the phosphor compositions described in Table 1. This table compiles the results of the determination of quantum efficiency for phosphors which have been produced analogously to the abovementioned exemplary embodiment, with the A-cation mixture Ba_{0.20}Ca_{0.15}Mg_{0.60}Eu_{0.05} or the A-cation mixture Ba_{0.38}Mg_{0.57}Eu_{0.05} but in each case a different ratio w=B₂S₃/AS. The quantum efficiency increases considerably if w is selected to be either lower than 1 or higher than 1, with the emission wavelength remaining unchanged, with a maximum emission intensity of 532 nm to 538 nm or 508 nm-513 nm. A decrease in the quantum efficiency, an increase in the reflectivity and a different maximum of the emission wavelength of 548 nm was determined for w=1.2, indicating that the range of existence of the relevant phosphor formation has been exceeded. In particular, the emission wavelength of 548 nm indicates the formation of a calcium-rich thiogallate lattice. This limit value in each case varies slightly as a function of the precise composition of the cation mixture A.

On account of the complex reaction mechanisms involved in the formation of the phosphor compositions given in the exemplary embodiments and the modification of the atomic crystal structure resulting from the changes in composition, it is assumed that a number of effects contribute to the observed dependency of the quantum efficiency on the cation ratio A:B. On the one hand, changing the A:B ratio may contribute to better conversion of the reaction product. As a result, disadvantageous secondary products and residual precursor and intermediate products are avoided. On the other hand, the incorporation of the activator Eu²⁺can also be promoted with a view to more complete and less disruptive incorporation in the crystal lattice of the thiometallates. It may also be important to more successively achieve a sulfur stoichiometry which conforms to the correct balance and can be more successfully matched to the local atomic cation composition using a core-shell formation model. Overall, the changed phosphor composition leads to increased perfection of the phosphor product and/or to a reduction in the number of non-radiating recombination centers which reduce the QE.

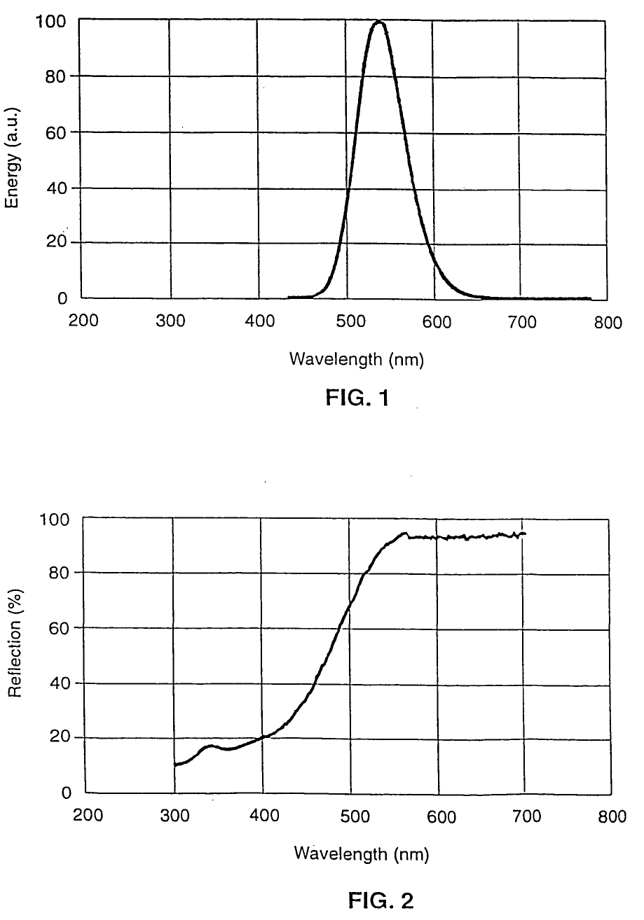

FIG. 1 shows the emission spectrum of the phosphor (Ba_{0.20}Ca_{0.15}Mg_{0.60}Eu_{0.05})S.1.1Ga₂S₃, which is described in the exemplary embodiment. The emission band lies in the green spectral region between approximately 460 nm and 620 nm. The emission maximum is at 538 nm, the mean wavelength at 544 nm. The color locus components are x=0.306; y=0.641. The quantum efficiency reaches 78% under narrow-band excitation at 400 nm. By comparison, the quantum efficiency of the phosphor, with w=1.0, is 62%.

This phosphor can be excited well by short-wave radiation between 300 and 450 nm. It is particularly advantageously suitable for use in LEDs for color conversion, as a so-called LED converter. In this case, the emission radiation from a UV-emitting LED is converted by means of one or more phosphors into visible light (in this case green or blue-green) or white light (mixture of red-emitting, green-emitting and blue-emitting phosphors). A second variant, when using a blue LED, is the use of one phosphor or of two phosphors (e.g. yellow-emitting or green-emitting and red-emitting phosphors), so that in this case too white light results. Technical details of this aspect can be found, for example, in U.S. Pat. No. 5,998,925.

The application of these phosphors as LED converters can be successfully achieved, for example, by solid casting by means of epoxy resins. For this purpose, the phosphor powder is dispersed in an epoxy resin, is placed onto the chip in the form of a drop and is cured. An important factor here is that the thiometallates have a nonpolar surface similar to that of the likewise nonpolar resin, which leads to good wetting. Further advantages reside in the fact that mixtures with other phosphors, such as YAG:Ce or YAG:Ce-based phosphors, are eminently successful, since the relative density of both classes of phosphor is similar, so that there is no segregation caused by sedimentation effects given a comparable particle size. The relative density of typical thiometallates is approx. 4.4 to 4.5 g/cm³, while that of YAG:Ce-based phosphors is typically 4.6 to 4.7 g/cm³. Sedimentation in the resin can be minimized by using mean particle sizes of <5 μm, in particular around 2±1 μm. The particle size is set by milling, e.g. in ball mills.

TABLE 1
Results of the determination of the quantum efficiency
for phosphors having the A-cation mixture
Ba_{0.20}Ca_{0.15}Mg_{0.60}Eu_{0.05} or Ba_{0.38}Mg_{0.57}Eu_{0.05} but in each case a
different B₂S₃/AS ratio w.

| | | | | | | Emission |
|---|---|---|---|---|---|---|
| | Ba | Ca | Mg | Eu | | wave- |
| | Molar | Molar | Molar | Molar | | length |
| w | proportion | proportion | proportion | proportion | QE % | (nm) |
| 0.9 | 0.20 | 0.15 | 0.60 | 0.05 | 69 | 533 |
| 1 | 0.20 | 0.15 | 0.60 | 0.05 | 62 | 534 |
| 1.1 | 0.20 | 0.15 | 0.60 | 0.05 | 78 | 538 |
| 1.2 | 0.20 | 0.15 | 0.60 | 0.05 | 65 | 548 |
| 0.9 | 0.38 | — | 0.57 | 0.05 | 76 | 509 |
| 1 | 0.38 | — | 0.57 | 0.05 | 60 | 510 |
| 1.1 | 0.38 | — | 0.57 | 0.05 | 68 | 512 |

1. A high-efficiency phosphor from the class of the thiometallates, based on the general formula AB₂S₄:D²⁺, where A is at least one divalent cation selected from the group consisting of Ba individually or in combination with Mg and/or Ca, and where B is at least one trivalent cation selected from the group consisting of Al, Ga, Y, and where europium and/or cerium is selected as activator D, characterized in that the composition of the phosphor is made up in such a way that it corresponds to the general formula (AS).w(B₂S₃), where the factor w may lie either in the range 0.8≦w≦0.98 or in the range 1.02≦w≦1.2.

2. The thiometallate phosphor as claimed in claim 1, characterized in that gallium, which may be partially replaced by aluminum, is selected as cation B.

3. The thiometallate phosphor as claimed in claim 1, characterized in that a combination of the metals Mg, Ca, Ba, on its own is selected as cation A.

4. The thiometallate phosphor as claimed in claim 1, characterized in that europium is selected as activator (which substitutes for A).

5. The thiometallate phosphor as claimed in claim 1, characterized in that (AS).w(Ga₂S₃), where A=MgₐCa_{b}Ba_{c}Euₜ, with a+b+c+t=1 with the ranges: 0.4≦a≦0.8; 0.05≦b≦0.35; 0.05≦c≦0.4; 0.01≦t≦0.1; 0.8≦w≦0.98 or 1.02≦w≦1.2.

6. The thiometallate phosphor as claimed in claim 1, characterized in that (AS).w(Ga₂S₃), where A=MgₐBa_{b}Euₜ, with a+b+t=1 with the ranges: 0.4≦a≦0.8; 0.1≦b≦0.59; 0.01≦t≦0.1; 0.8≦w≦0.98 or 1.02≦w≦1.2.

7. A process for producing a high-efficiency phosphor from the class of the thiometallates as claimed in one of the preceding claims, characterized by the following process steps:
a) production of a suspension of nitrates corresponding to the desired composition as set forth in claims 1 to 6;
b) drying of this suspension to a residual moisture content of <1% by weight at T≦300° C., in order to produce a finely dispersed nitrate mixture;
c) milling of the nitrate mixture in a mortar mill at room temperature for 10 min to 60 min, preferably 20 min;
d) pyrolysis of the milled nitrate mix at 500-700° C., preferably at 600° C., in an Ar or N₂ atmosphere in order to produce a finely dispersed metal oxide mixture of the desired composition;
e) initial reaction of the metal oxide mixture at 800-1000° C., preferably 900-950° C., in flowing H₂S or CS₂ atmosphere or combinations thereof for 1-6 hours, preferably 4 hours;
f) milling the reaction product as in step c;
g) second reaction at 800-1000° C., preferably 900-950° C., in a flowing H₂S or CS₂ atmosphere or combinations thereof for 1-6 h, preferably for 2 h.

8. The process as claimed in claim 7, characterized in that in steps e) and g) the quantitative flow rate is 50-500 ml/min, preferably 120 ml/min, and the gas atmosphere comprises H₂S or CS₂ and Ar or N₂ as carrier gas, with 10-50% of H₂S or CS₂ or mixtures thereof, preferably 30% of H₂S or CS₂ or mixtures thereof.

9. The process as claimed in claim 7, characterized in that in steps e) and g) the heating up to the reaction temperature takes place at 0.5-20 K/min, ideally 10 K/min.

10. The process as claimed in claim 7, characterized in that in steps e) and g) the cooling takes place at 0.5-20 K/min, ideally 10 K/min.

11. The use of the phosphors as claimed in claims 1 to 6, characterized in that they are used, for example, in UV-emitting or blue-emitting LEDs for color conversion, individually, in combination with other phosphors of claims 1-6, and in combinations with other known phosphors.

12. The use of the phosphors as claimed in claims 1 to 6, characterized in that they are used, for example, in plasma displays, individually, in combination with other phosphors of claims 1-6, and in combinations with other known phosphors, in order to convert the short-wave plasma discharge radiation into visible light.
